(19) United States
(12) Patent Application Publication
(10) Pub. No.: US 2024/0063503 A1
(43) Pub. Date: Feb. 22, 2024

(54) BATTERY PROTECTIVE THERMAL ENCLOSURE

(71) Applicant: STEWART & STEVENSON LLC, Houston, TX (US)

(72) Inventors: Ryan LOOFS, Leander, TX (US); Michael WARHUS, Leander, TX (US); David ELDRIDGE, Leander, TX (US)

(21) Appl. No.: 18/143,363

(22) Filed: May 4, 2023

Related U.S. Application Data
(60) Provisional application No. 63/398,725, filed on Aug. 17, 2022.

(51) Int. Cl. H01M 50/383; H01M 50/593; H01M 10/0525; H01M 50/143

(52) U.S. Cl. CPC H01M 50/383; H01M 50/593; H01M 10/0525; H01M 50/143

(57) ABSTRACT

A battery enclosure includes a top wall, bottom wall, and side walls connected to each other, forming an inside and an outside of the battery enclosure. The battery enclosure further includes a relief vent, the relief vent extending through the top wall or side wall and a battery enclosure pressure relief, the battery enclosure pressure relief including a deflagration panel, wherein the deflagration panel is a burst disk or explosion vent.

### CROSS-REFERENCE TO RELATED APPLICATIONS

This application is a nonprovisional application which claims priority from U.S. provisional application No. 63/398,725, filed Aug. 17, 2022, which is incorporated by reference herein in its entirety.

### TECHNICAL FIELD/FIELD OF THE DISCLOSURE

The present disclosure relates generally to protective enclosures for batteries.

### BACKGROUND OF THE DISCLOSURE

Thermal runaway in a battery system often begins in a single cell. Thermal runaway may be characterized by primary effects including vapor combustion, over-pressurization, explosion of the cell contents, and generation of heat and/or flames. These effects may cascade from the initial cell(s) where thermal runaway originates to other adjacent cells, leading to propagation of thermal runaway throughout a battery system. Secondary effects of non-contained thermal runaway may include harm to people, environmental damage, and/or destruction of property. It is therefore desirable to contain the primary effects of a thermal runaway event to within the battery system enclosure such that the secondary effects are prevented.

### SUMMARY

The disclosure includes a battery enclosure. The battery enclosure includes a top wall, bottom wall, and side walls connected to each other, forming an inside and an outside of the battery enclosure. The battery enclosure further includes a relief vent, the relief vent extending through the top wall or side wall and a deflagration assembly, the deflagration assembly including a deflagration panel, wherein the deflagration panel is a burst disc or an explosion vent.

The disclosure also includes a battery system. The battery system includes a battery enclosure having a battery module positioned therein. The battery enclosure includes a top wall, bottom wall, and side walls connected to each other, forming an inside and an outside of the battery enclosure. The battery enclosure also includes a relief vent, the relief vent extending through the top wall or side wall and a deflagration assembly the deflagration assembly including a deflagration panel, wherein the deflagration panel is a burst disk or explosion vent. The battery system further includes a lithium-ion battery cell positioned within each battery module and an electronics control tray within electrical communication with the battery module.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1a is an isometric view of the outside of a battery enclosure consistent with certain embodiments of the present disclosure.

FIG. 1B is an exploded isometric detail view of a deflagration assembly consistent with certain embodiments of the present disclosure.

FIG. 2a is an exploded isometric detail view of selected components of a battery system consistent with certain embodiments of the present disclosure.

FIG. 2b is an isometric detail view of selected components within a battery system consistent with certain embodiments of the present disclosure.

FIG. 3 is a normal-plane view of the battery enclosure with its front access panel removed consistent with some embodiments of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

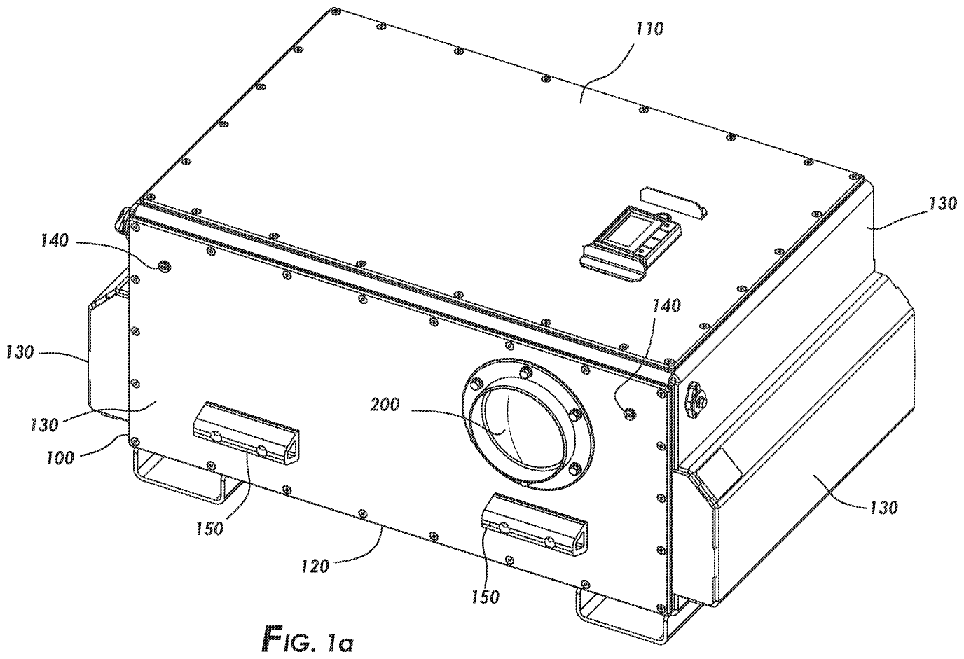

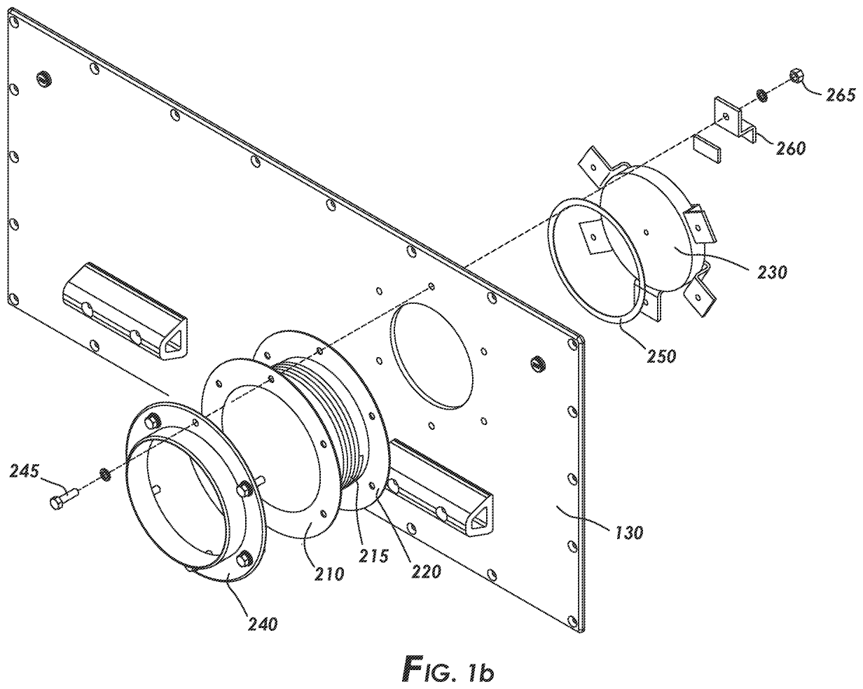

FIG. 1a depicts battery enclosure 100 consistent with certain embodiments of the present disclosure. FIG. 1a depicts top wall 110, bottom wall 120, and side walls 130; in certain embodiments, one or more of top wall 110, bottom wall 120, and side walls 130 may be comprised of a mounting flange and a corresponding removable access panel. Battery enclosure 100 may include one or more relief vents 140. The one or more relief vents 140 may equalize internal and external pressures, which minimizes potential for inadvertent rupture of deflagration panel 210 (shown in FIG. 1B). Relief vents may extend through top wall 110, bottom wall 120 and/or side walls 130. Relief vents 140 may be constructed of, for example, metal, ceramic, or a composite, such as stainless steel. In certain embodiments, relief vents 140 may be sized, for example and without limitation, dependent upon such factors as the anticipated ambient/internal pressure change for the intended application of battery system 10, altitude, temperature, battery enclosure volume, and maximum allowed pressure within battery enclosure 100.

In certain embodiments, battery enclosure 100 may include one or more dock bumpers 150 positioned on side walls 130. Dock bumpers 150 may be constructed of metal, plastic, rubber or other suitable materials to protect against physical contact of foreign objects, including other battery enclosures 100, against side walls 130. Dock bumpers 150 may also protect against interferences that may rupture deflagration panel 210.

As shown in FIG. 1B, battery enclosure 100 may include one or more deflagration assemblies 200. Deflagration assembly 200 may include two primary parts—deflagration panel 210 and flame arrester 230. Deflagration panel 210 may be a burst disc or an explosion vent designed to rupture at a predetermined burst pressure or temperature. A burst temperature may be, for example, greater than or equal to 100° C. A burst pressure for deflagration panel 210 may be predetermined based on, for example, the free-air internal volume of battery enclosure 100, the maximum allowed pressure within battery enclosure 100, the anticipated volume of gas products that could be released during a thermal runaway event, the size of relief vents 140, and the anticipated ambient conditions surrounding battery enclosure 100 that may affect internal pressure within battery enclosure 100. Deflagration panel 210 may further include a predetermined size based on, for example, the free-air internal volume of battery enclosure 100, the maximum allowed pressure within battery enclosure 100, and the anticipated volume of gas products that may be released during thermal runaway. In certain embodiments, deflagration panel 210 may include monitoring device 215, shown in FIG. 1b, for example, as a coil, to indicate whether deflagration panel 210 has ruptured.

Flame arrester 230 acts to retard flames from escaping through a ruptured deflagration panel 210. Thus, should combustible vapors and/or solids within battery enclosure 100 catch fire, flame arrester 230 retards or prevents such flames from escaping through ruptured deflagration panel 210.

In certain embodiments, deflagration assembly 200 may be fastened together and held to side wall 130 through flange 240, retaining brackets 260, and flange bolts 245. Flange 240 may be positioned on the outside of side wall 130, with flange bolts 245 passing through flange 240, deflagration panel 210, outer gasket 220, side wall 130, and retaining brackets 260 to be secured by lock nuts 265. In addition, flame arrester gasket 250 may be positioned between flame arrester 230 and the inside of side wall 130.

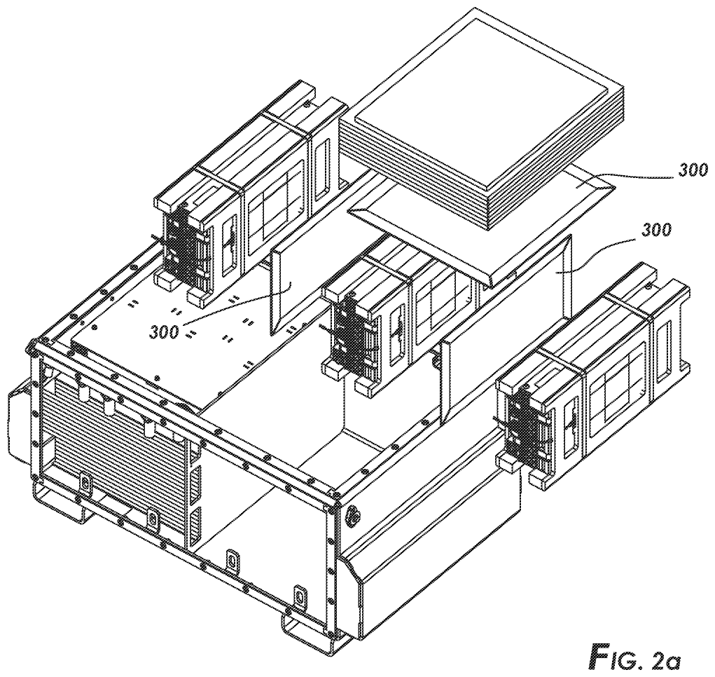

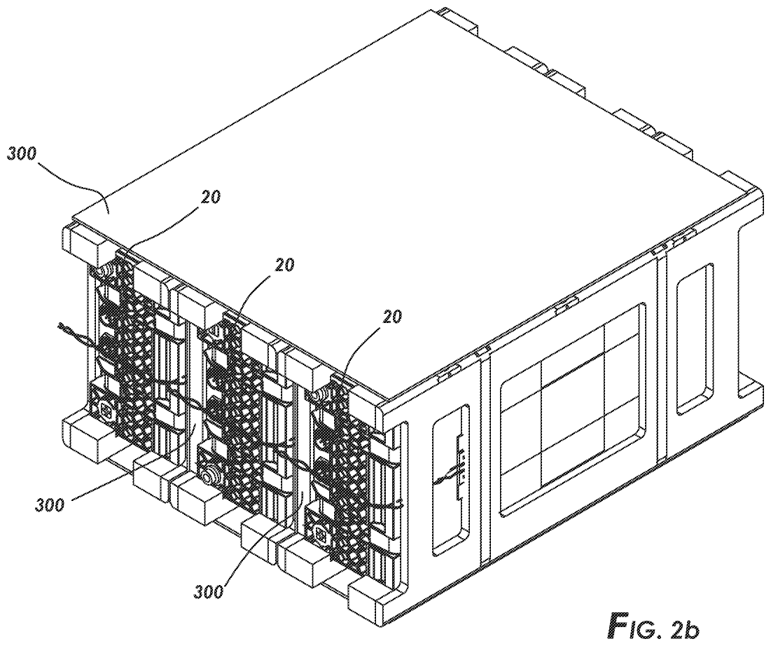

In some embodiments, thermal barrier plates 300 may be placed around and/or between battery cells or battery modules 20 as shown in FIG. 2a and FIG. 2b to impede propagation of thermal runaway. Barrier plates 300 may restrict the propagation of a thermal runaway event between battery cells 25 or battery modules 20 to provide protection as to retard or prevent propagation from occurring. Barrier plates 300 may be formed of an insulating and/or intumescent material and may be a composite consisting of multiple layers of such materials along with additional metallic or ceramic layers which are used to strengthen the barrier plates. Barrier plates 300 may be separate pieces, or as one connected, cast, or molded piece. Barrier plates 300 may function at temperature ranges up to 1000° F.-2000° F., depending on the material of construction of barrier plates 300. Materials for barrier plates 300 may include ceramic, silica, or other materials with fire resistance and/or fire containment properties. In certain embodiments, barrier plates 300 may also be integrated with one or more of top wall 110, bottom wall 120, and side walls 130 to insulate the exterior of battery enclosure 100 from the primary effects of a thermal runaway event within.

In certain embodiments, battery enclosure 100 may include additional auxiliary components, such as wraps, tapes, or other intumescent gap filling/sealing materials, to further protect the battery system in the event of thermal runaway.

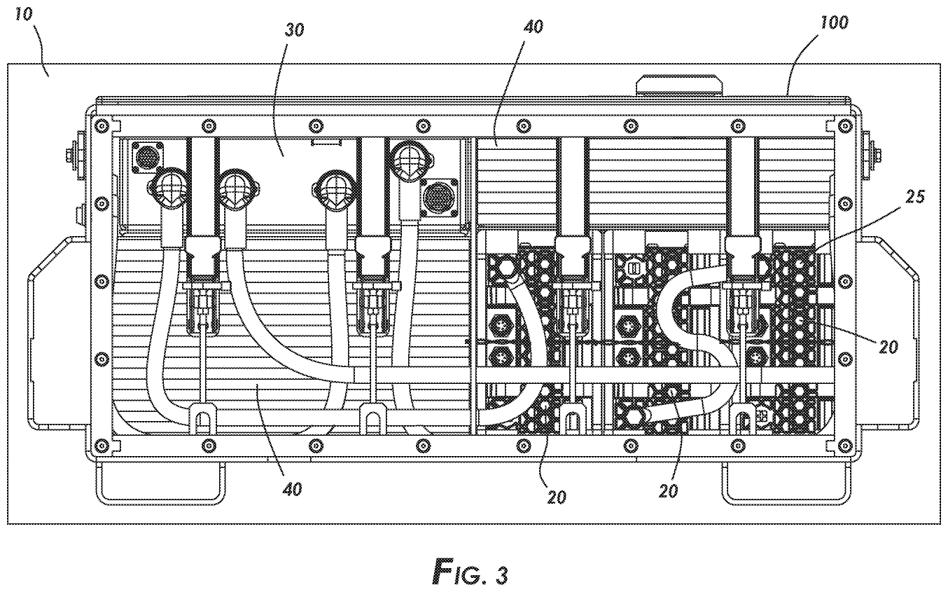

Battery system 10 may include one or more batteries grouped in a variety of packs, cells, modules, or other arrangements within battery enclosure 100. As shown in FIG. 3, in certain embodiments, battery system 10 may include one or more battery modules 20, which contain lithium-ion battery cells 25. In some embodiments, battery system 10 may include electronics control tray 30. Electronics control tray 30 may act to control various aspects of lithium-ion battery cells, such as voltages, currents, and temperatures. In some embodiments, such as when fewer battery modules 20 are present within battery enclosure 100, gap filler plates 40 may be inserted. Gap filler plates 40 may be adapted to be removed from battery enclosure 100 and replaced with additional battery modules 20.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A battery enclosure comprising:
a top wall, bottom wall, and side walls connected to each other, forming an inside and an outside of the battery enclosure;
a relief vent, the relief vent extending through the top wall or side wall; and
a deflagration assembly, the battery enclosure pressure relief including a deflagration panel, wherein the deflagration panel is a burst disk.

2. The battery enclosure of claim 1, wherein the relief vent is adapted to equalize pressure between the inside of the battery enclosure and the outside of the battery enclosure.

3. The battery enclosure of claim 1 further comprising a dock bumper, the dock bumper positioned on the side wall.

4. The battery enclosure of claim 1, wherein the deflagration assembly includes:
a flange having flange bolts therethrough, wherein the flange bolts pass through an outside gasket, the deflagration panel, an inside gasket, the side wall; and
a flame arrester, the flame arrester secured to at least one of the flange bolts.

5. The battery enclosure of claim 1, wherein the top wall, the bottom wall, and/or the side walls include a barrier plate, the barrier plate positioned on the inside of the battery enclosure.

6. The battery enclosure of claim 5, wherein the barrier plates are separate pieces.

7. The battery enclosure of claim 5, wherein the barrier plates are one connected or molded piece.

8. The battery enclosure of claim 5, wherein the barrier plates are constructed of ceramic or silica.

9. The battery enclosure of claim 1, wherein a barrier plate is placed between battery modules positioned within the inside.

10. A battery system comprising:
a battery enclosure having a battery module positioned therein, the battery enclosure including:
a top wall, bottom wall, and side walls connected to each other, forming an inside and an outside of the battery enclosure;
a relief vent, the relief vent extending through the top wall or side wall; and
a battery enclosure pressure relief, the battery enclosure pressure relief including a deflagration panel, wherein the deflagration panel is a burst disk or explosion vent;
a lithium-ion battery cell positioned within each battery module; and
a electronics control tray within electrical communication with the battery module.

11. The battery system of claim 10 further comprising gap filler plates positioned with the battery enclosure.

12. The battery system of claim 10, wherein the relief vent is adapted to equalize pressure between the inside of the battery enclosure and the outside of the battery enclosure:

13. The battery system of claim 10 further comprising a dock bumper, the dock bumper positioned on the side wall.

14. The battery system of claim 10, wherein the battery enclosure pressure relief includes:
a flange having flange bolts therethrough, wherein the flange bolts pass through an outside gasket, the deflagration panel, and an inside gasket, the side wall; and
a flame arrester, the flame arrester secured to at least one of the flange bolts.

15. The battery system of claim 9, wherein the top wall, the bottom wall, and/or the side walls include a barrier plate, the barrier plate positioned on the inside of the battery enclosure.

16. The battery system of claim 14, wherein the barrier plates are separate pieces.

17. The battery system of claim 14, wherein the barrier plates are one connected or molded piece.

18. The battery system of claim 14, wherein the barrier plates are constructed of ceramic or silica.

19. The battery system of claim 10, wherein a barrier plate is placed between battery modules positioned within the inside.
